(19) United States
(12) Patent Application Publication
(10) Pub. No.: US 2026/0320389 A1
(43) Pub. Date: Oct. 15, 2026

(54) STREAMING DICTIONARY ENCODING FOR SYNTHETIC DATA GENERATION

(71) Applicant: Rockfish Data, Inc., San Ramon, CA (US)

(72) Inventors: Daniel Nelson, San Francisco, CA (US); Aadyaa Maddi, Pittsburgh, PA (US); Nathan Haugo, Berkeley, CA (US); Vyas Sekar, Pittsburgh, PA (US)

(21) Appl. No.: 19/642,363

(22) Filed: Apr. 8, 2026

Related U.S. Application Data
(60) Provisional application No. 63/786,118, filed on Apr. 9, 2025.

(51) Int. Cl. G06N 3/08; G06N 3/0475

(52) U.S. Cl. CPC G06N 3/08; G06N 3/0475

(57) ABSTRACT

A method of encoding streamed data for use in training a model using a neural network includes ingesting a first streamed dataset corresponding to a first data epoch, updating a streamed dictionary using the first streamed dataset to generate a first dictionary snapshot corresponding to the first data epoch, and encoding the first streamed dataset using the first dictionary snapshot to generate a first encoded dataset. A program may be stored in non-transitory computer-readable media. The program may include instructions that, when executed by one or more processors, encode streamed data for use in training a model using a neural network by performing the method. A synthetic data generation system may include a streamed data source, an encoding storage configured to store a streamed dictionary, the one or more processors, and the non-transitory computer-readable media.

### CROSS-REFERENCE TO RELATED APPLICATIONS

This application claims priority to Provisional Application No. 63/786,118 filed on Apr. 9, 2025. The disclosure of the aforementioned application is hereby incorporated by reference in its entirety.

### TECHNICAL FIELD

The present invention relates generally to generative modeling, and, in particular embodiments, to systems and methods for encoding source data for training generative models.

### BACKGROUND

Enterprises and service providers generate large volumes of operational data in the course of their business activities. This operational data can include network flow records collected by telecommunications operators, user transaction logs maintained by financial institutions, application usage traces gathered by mobile app providers, system performance metrics, and many other forms of continuously generated telemetry. The volume, velocity, and variety of this operational data have grown substantially as organizations have expanded the scope and granularity of their data collection practices.

Operational data serves as a foundation for a wide range of data-driven workflows. Organizations use this data for network monitoring, anomaly detection, capacity planning, performance optimization, compliance auditing, and business intelligence. The value of operational data extends beyond its immediate analytical uses, as it can also serve as a basis for training machine learning models, testing new software systems, and validating data pipelines.

Deep generative modeling has emerged as a technique for producing synthetic datasets that preserve statistical properties of real data while addressing constraints that limit the use of the original data. Generative models can be trained on a source dataset and then used to produce synthetic data that approximates the distributions, correlations, and patterns present in the source. Synthetic data generation can help address data scarcity in scenarios where real data is limited, enable testing and development workflows without exposing sensitive production data, and support compliance with privacy regulations that restrict the sharing or retention of certain categories of information.

Tabular data, which organizes information into rows and columns with each column representing a distinct attribute or field, is a common format for operational data. Tabular datasets frequently contain fields with high cardinality, meaning that the number of distinct values a field can take is large. Examples of high-cardinality fields include internet protocol addresses, uniform resource locators, user identifiers, device identifiers, and geographic coordinates. High-cardinality fields pose challenges for generative modeling because the large number of distinct values increases the dimensionality of the data representation and correspondingly increases the computational cost of training.

In many operational settings, data does not exist as a single static collection but rather arrives continuously over time. Data collection systems ingest new records on a recurring basis, with ingestion intervals that can range from seconds to hours to days depending on the application. The continuously arriving nature of operational data means that the set of values observed for any given field can change over time as new entities, events, or conditions emerge. For instance, new websites may become popular, new devices may enter the network, new user accounts may be created, or new geographic regions may become active. This ongoing evolution of the data domain presents challenges for any workflow that relies on a fixed representation of the value space.

### SUMMARY

In accordance with an embodiment of the invention, a method of encoding streamed data for use in training a model using a neural network includes ingesting a first streamed dataset corresponding to a first data epoch, updating a streamed dictionary using the first streamed dataset to generate a first dictionary snapshot corresponding to the first data epoch, and encoding the first streamed dataset using the first dictionary snapshot to generate a first encoded dataset.

In accordance with another embodiment of the invention, a non-transitory computer-readable medium storing a program includes instructions that, when executed by one or more processors, encode streamed data for use in training a model using a neural network by ingesting a first streamed dataset corresponding to a first data epoch, updating a streamed dictionary using the first streamed dataset to generate a first dictionary snapshot corresponding to the first data epoch, and encoding the first streamed dataset using the first dictionary snapshot to generate a first encoded dataset.

In accordance with still another embodiment of the invention, a synthetic data generation system includes one or more processors, a streamed data source, an encoding storage configured to store a streamed dictionary, and at least one non-transitory computer-readable medium storing a program including instructions that, when executed by the one or more processors, cause the synthetic data generation system to generate synthetic data by ingesting a first streamed dataset corresponding to a first data epoch, updating the streamed dictionary using the first streamed dataset to generate a first dictionary snapshot corresponding to the first data epoch, encoding the first streamed dataset using the first dictionary snapshot to generate a first encoded dataset, training a model using the first encoded dataset to generate a trained generative model, generating an encoded synthetic dataset using the trained generative model, and decoding the encoded synthetic dataset using the streamed dictionary to generate a decoded synthetic dataset.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates an example encoding process that uses a streamed dictionary to encode streamed data for use in training a model using a neural network in accordance with embodiments of the disclosure;

FIG. 2 illustrates an example synthetic data generation process that uses a streamed dictionary to encode and decode datasets in accordance with embodiments of the disclosure;

FIG. 3 illustrates an example encoding and decoding process in accordance with embodiments of the disclosure;

FIG. 4 illustrates a method of encoding streamed data for use in training a model using a neural network in accordance with embodiments of the disclosure;

FIG. 5 illustrates an example synthetic data generation system in accordance with embodiments of the disclosure;

FIG. 6 illustrates another example synthetic data generation system in accordance with embodiments of the disclosure;

FIG. 7 illustrates a visual representation of a conventional model generation process;

FIG. 8 illustrates a visual representation of a conventional encoding process using a static dictionary; and

FIG. 9 illustrates another visual representation of a conventional encoding process using a static dictionary.

Corresponding numerals and symbols in the different figures generally refer to corresponding parts unless otherwise indicated. The figures are drawn to clearly illustrate the relevant aspects of the embodiments and are not necessarily drawn to scale. The edges of features drawn in the figures do not necessarily indicate the termination of the extent of the feature.

### DETAILED DESCRIPTION OF ILLUSTRATIVE EMBODIMENTS

The making and using of various embodiments are discussed in detail below. It should be appreciated, however, that the various embodiments described herein are applicable in a wide variety of specific contexts. The specific embodiments discussed are merely illustrative of specific ways to make and use various embodiments, and should not be construed in a limited scope.

Enterprises and service providers continuously collect large volumes of operational data such as logs, system traces, network flow records, and user transactions to drive various data-driven workflows. To address challenges related to data silos, sparsity, and constraints imposed by privacy, cost, and compliance requirements, deep generative modeling can be employed to produce synthetic datasets from this operational data. The synthetic datasets can then be used for downstream tasks including testing, analytics, compressed data transmission, and what-if scenario analysis.

Training generative models on operational data is challenging because such data can be high dimensional and high volume, imposing significant scalability and cost constraints. Data transformation and encoding techniques can relax these constraints by reducing the dimensionality of the data prior to training. For example, high-cardinality string fields in tabular datasets can be encoded into simpler integer representations using encoding dictionaries that map observed values to compact encoded values. The generative modeling workflow can be extended to incorporate the encoding as an integral part of both the training and generation processes.

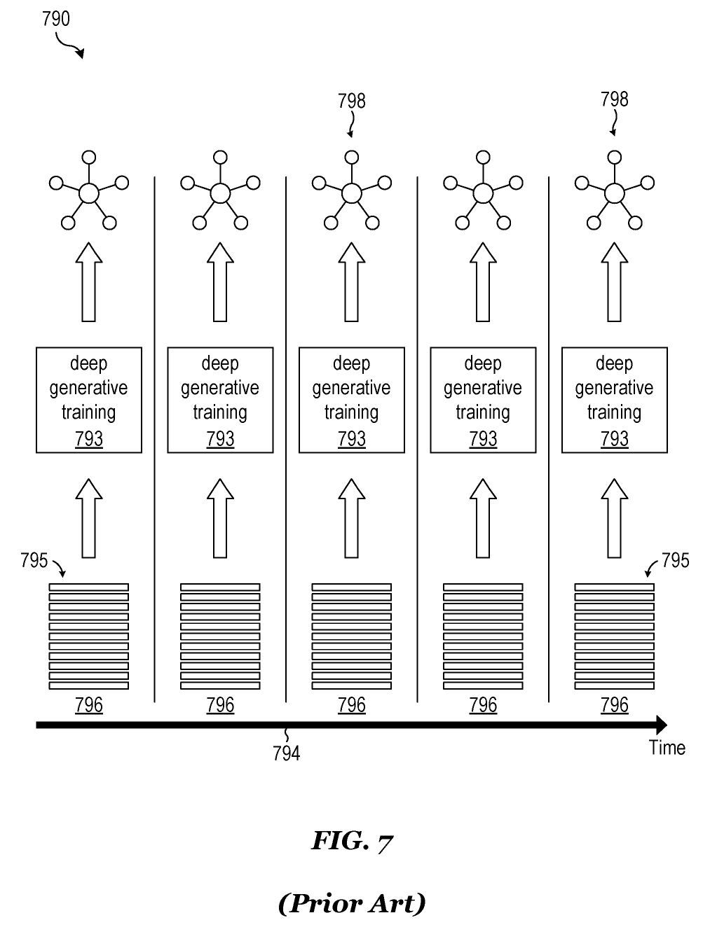

Conventional approaches to synthetic data generation, however, assume a static or “data at rest” model where a single dataset is used to train a generative model and produce synthetic data. This assumption is at odds with the reality of operational settings where data arrives continuously in batches and the domain of values for any given field evolves over time. A conventional model generation process 790 is shown in FIG. 7. In conventional model generation process 790, a source dataset 795 is collected during each data epoch 796. Time evolution 794 (depicted by a black arrow) shows the evolution of time as additional source datasets are collected. Each data epoch 796 represents a window of time during which operational data such as logs, system traces, network flow records, or user transactions is gathered from one or more data sources. For each source dataset 795, a training step 793 is performed to train a generative model 798 that can subsequently be used to generate synthetic data approximating the statistical properties and patterns present in the source dataset 795 from which it was trained.

Data encoding and transformation techniques have been applied to reduce the effective dimensionality of tabular data prior to generative model training. Encoding techniques map the original values of a field to a more compact representation. For example, dictionary-based encoding assigns an integer index to each unique value observed in a field, replacing high-cardinality string values with lower-dimensional integer representations. Other encoding approaches include one-hot encoding, which represents each unique value as a binary vector, label encoding, which assigns ordinal integers to categorical values, and frequency-aware encoding, which incorporates information about the relative frequency of values into the encoded representation. The choice of encoding technique for a given field can depend on the nature of the field, the intended downstream use of the synthetic data, and the fidelity requirements of the application.

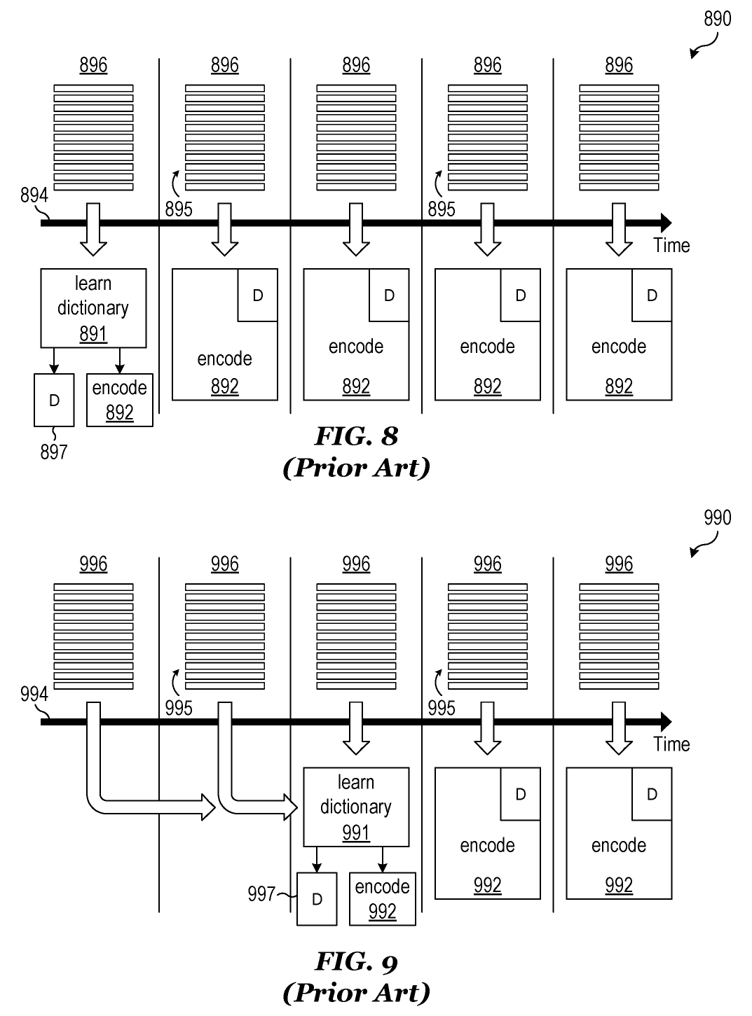

One conventional encoding approach learns an encoding dictionary from an initial data batch and applies that static dictionary to all subsequent batches. For example, a conventional static dictionary process 890 is shown in FIG. 8. In conventional static dictionary process 890, source datasets 895 are collected during successive data epochs 896 along a time evolution 894. During the first data epoch, a conventional static learning step 891 is performed on the first source dataset to learn a static dictionary 897 that maps observed values in the first source dataset to encoded representations. Once static dictionary 897 is learned from the first source dataset, it remains unchanged for all subsequent data epochs. A conventional encoding step 892 encodes each source dataset 895 using static dictionary 897 before the encoded data is passed to a training step to produce a generative model. This approach suffers from serious correctness problems because the initial snapshot may not cover the full range of values that appear in later batches, forcing system designers to either drop data records containing out-of-dictionary values or randomly remap those values to existing dictionary entries, both of which can have disastrous consequences for downstream tasks.

Another conventional encoding approach attempts to build a global dictionary by aggregating data over an extended bootstrapping period before encoding begins. A conventional global dictionary process 990 is shown in FIG. 9. In conventional global dictionary process 990, source datasets 995 are collected during successive data epochs 996 along a time evolution 994. Rather than learning a dictionary from only the first source dataset, conventional global dictionary process 990 aggregates multiple initial source datasets collected over several early data epochs and performs a conventional global learning step 991 on the aggregated data to learn a global dictionary 997. By using multiple source datasets from an extended bootstrapping period, global dictionary 997 may achieve broader coverage of the value domain than a dictionary learned from a single source dataset. Once global dictionary 997 is assembled, a conventional encoding step 992 encodes each subsequent source dataset using global dictionary 997 before the encoded data is passed to a training step. However this approach requires waiting for a long time to observe a sufficient portion of the value domain. Further, the conventional global static dictionary is still unable to handle domain evolution or changes in the frequency distribution of values over time because it is still fixed in time.

In accordance with embodiments herein described, the invention proposes to address these limitations by updating a dictionary in a continuous streaming fashion that is correct by construction. Rather than relying on a static dictionary based on a single dataset or deferring encoding until a global static dictionary can be assembled, the disclosed methods update the streamed dictionary incrementally as each new batch of data arrives (e.g., a dataset for a given epoch). A separate encoding storage tracks the streamed dictionary (e.g., dictionaries for each field of each dataset type) and may maintain a history of dictionary snapshots. When training a generative model on a new dataset, the system may retrieve the latest dictionary for each relevant field, update the dictionary to incorporate any newly observed values, send the updated dictionary back to the encoding storage, and then encode the dataset using the updated dictionary. The trained generative model may be associated with metadata that records the specific dictionary snapshot and configuration workflow used to produce it, allowing synthetic data generated using the model to be decoded using the same dictionary snapshot.

The disclosed streaming dictionary approach described herein may provide several advantages over conventional static dictionary approaches as well as offer various improvements to the functioning of computers and to other technologies or technical fields. For example, correctness problems of static dictionaries may be advantageously avoided by ensuring that out-of-dictionary values are never dropped or randomly remapped. A streamed dictionary may also beneficially eliminate the need for a prolonged bootstrapping period because the dictionary is ready to use from the first dataset and then continuously improves its coverage with each subsequent dataset. The approach may also have the advantage of enabling flexible behavior when generating synthetic data. For instance, synthetic data may be generated using either the dictionary that was current at training time (e.g., to faithfully replay historical conditions) or using a different dictionary snapshot (e.g., a newer snapshot or broader snapshot to enable extrapolation and what-if analysis involving values that were not present in the original training data). The streaming dictionary approach may have a further advantage of accommodating per-field encoding strategies where different fields can employ different encoding algorithms, such as one-hot encoding, label encoding, or frequency-aware encoding. The encoding strategies may themselves evolve over time in response to policy changes, schema changes such as the addition of new data columns, or the discovery of previously unknown dependencies between fields that warrant joint encoding.

Aspects of this disclosure describe a method, a non-transitory computer-readable medium, and a synthetic data generation system for encoding streamed data for use in training a model using a neural network. In embodiments, a streamed dataset corresponding to a first data epoch is ingested. A dictionary (i.e., a “streamed” dictionary) is updated using the streamed dataset to generate a dictionary snapshot that also corresponds to the first data epoch. The streamed dataset is then encoded using the dictionary snapshot to generate an encoded dataset. Because the streamed dictionary is updated before encoding, the encoded dataset reflects the full domain of values present in the streamed dataset.

The encoded dataset can then be used to train a model using a neural network to generate a trained generative model. Specifically, an encoded synthetic dataset can be generated using the trained model, and the encoded synthetic dataset can be decoded using the streamed dictionary to generate a decoded synthetic dataset. The decoded synthetic dataset may also reflect the full domain of values present in the streamed dataset of the first data epoch. In various embodiments, the streamed dictionary can be used to generate decoded synthetic datasets that have a different (e.g., extrapolated) domain of values than the streamed dataset of the first data epoch.

In embodiments, the streamed dictionary is continuously updated as additional datasets corresponding to additional data epochs are ingested. Each additional dataset is used to update the streamed dictionary to generate additional dictionary snapshots corresponding to the respective additional data epochs, and each additional dataset is encoded using the respective dictionary snapshot. In this manner, the streamed dictionary grows and adapts over time, maintaining coverage of the evolving data domain without requiring a prolonged bootstrapping period or advance knowledge of all possible values.

In embodiments, the streamed datasets may include both dynamic fields and static fields. Dynamic fields are fields whose domain of values are allowed to (e.g., expected to) change across data epochs, such as fields representing websites visited, user identifiers, or device types. Static fields are fields with a domain of values that remains substantially unchanged over time. Then the streamed dictionary is updated, only the dynamic fields of a given streamed dataset may be updated to generate a dictionary snapshot.

In some cases, streamed data may be stored rather than directly ingested. In embodiments, a stored dataset corresponding to an earlier data epoch may be ingested. The dictionary snapshot that is retrieved from the streamed dictionary is the latest dictionary snapshot before that earlier data epoch (i.e., the most recent snapshot relative to the data epoch of the dataset) so that an earlier dictionary snapshot corresponding to the earlier data epoch can be generated That is, previously collected data can be used to generate dictionary snapshots to update the streamed dictionary without overwriting dictionary snapshots of later data epochs that may have already been updated.

In embodiments, the streamed dictionary maintains dictionary snapshots that can be selected at decoding time to control the characteristics of the decoded synthetic data. For example, an encoded synthetic dataset may be decoded using the same dictionary snapshot used to encode the dataset for training the generative model. Alternatively, different dictionary snapshots may be used to generate and/or decode synthetic datasets (e.g., so that the decoded synthetic datasets include extrapolated synthetic data). Extrapolation enables the generation of synthetic data that reflects values or conditions that were not present in the training data but have appeared in a later or earlier epoch, in a different region, or in hypothetical scenarios supporting what-if analysis and scenario modeling. In various embodiments, the extrapolated synthetic data corresponds to a different or modified data epoch. In embodiments, the encoded synthetic dataset may be decoded using a combined dictionary generated by combining multiple dictionary snapshots of the streamed dictionary. The multiple dictionary snapshots that are combined may correspond to different data epochs, enabling a temporal aggregation that spans a broader range of observed values.

The multiple dictionary snapshots may also correspond to the same data epoch, but have other differences, such as when data is collected from different locations. The streamed dictionary may keep track of various identifiers of the dictionary snapshots in addition to data epoch, such as data collection location, to facilitate more complex extrapolation capabilities. In embodiments, the streamed dictionary includes location information of dictionary snapshots in addition to time information, enabling the system to distinguish between dictionary snapshots collected at different geographic or logical locations within the same data epoch. For example, a combined dictionary may be generated by combining multiple dictionary snapshots from the encoding storage that correspond to a given data epoch but correspond to different locations, producing a globalized dictionary snapshot that reflects the union of values observed across all locations for that epoch.

In one or more embodiments, at least one non-transitory computer-readable medium stores a program including instructions that, when executed, cause one or more processors to encode streamed data for use in training a model using a neural network by performing some or all of the above steps. A synthetic data generation system may include one or more processors, a streamed data source, an encoding storage configured to store a streamed dictionary, and at least one non-transitory computer-readable medium storing the program. These and additional details are further discussed below.

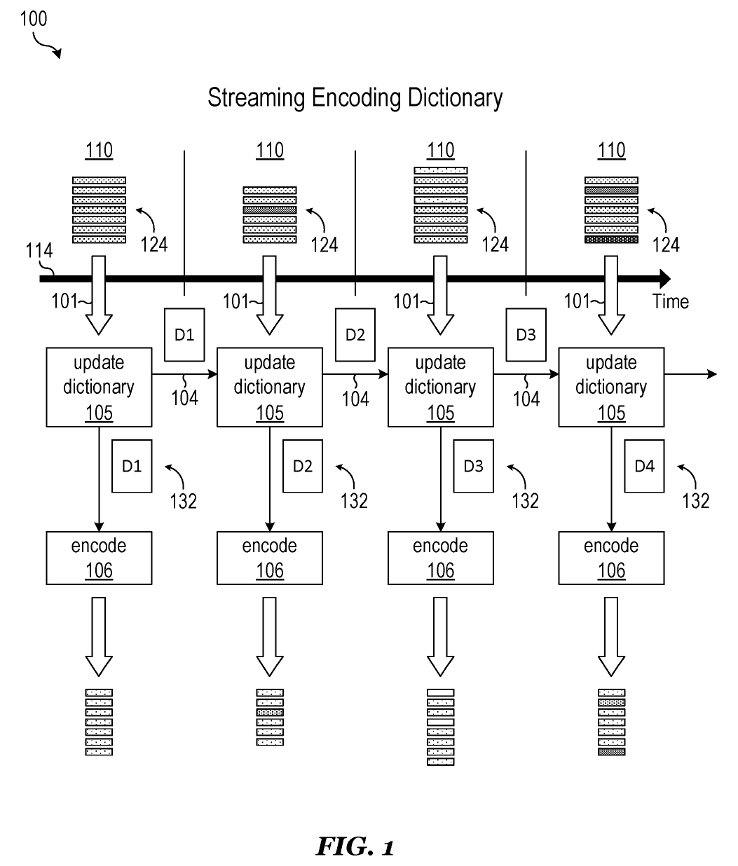

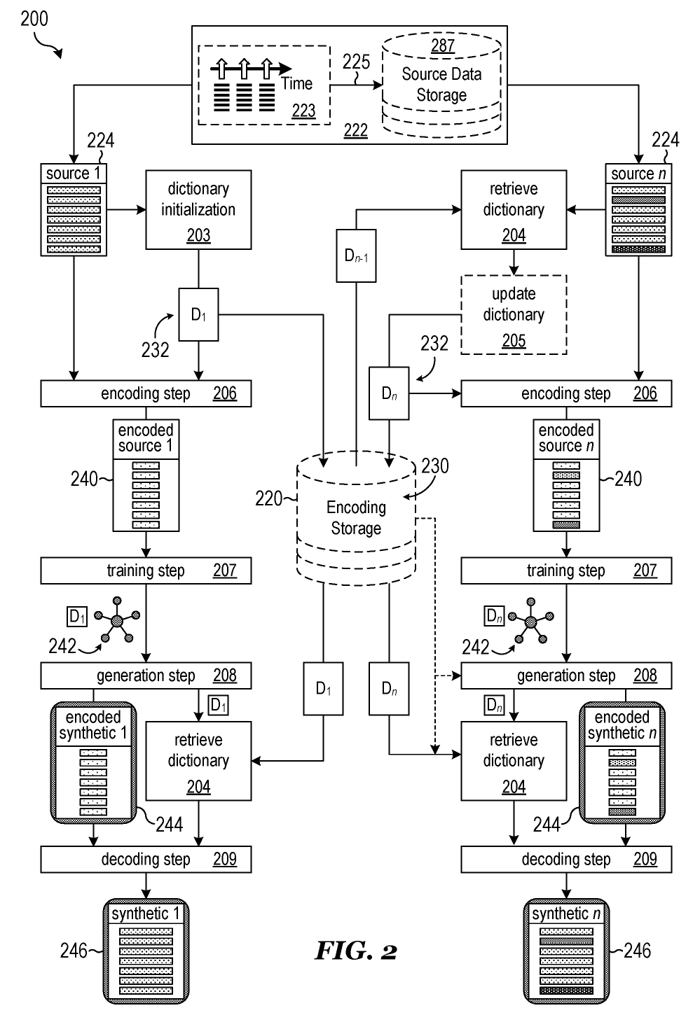

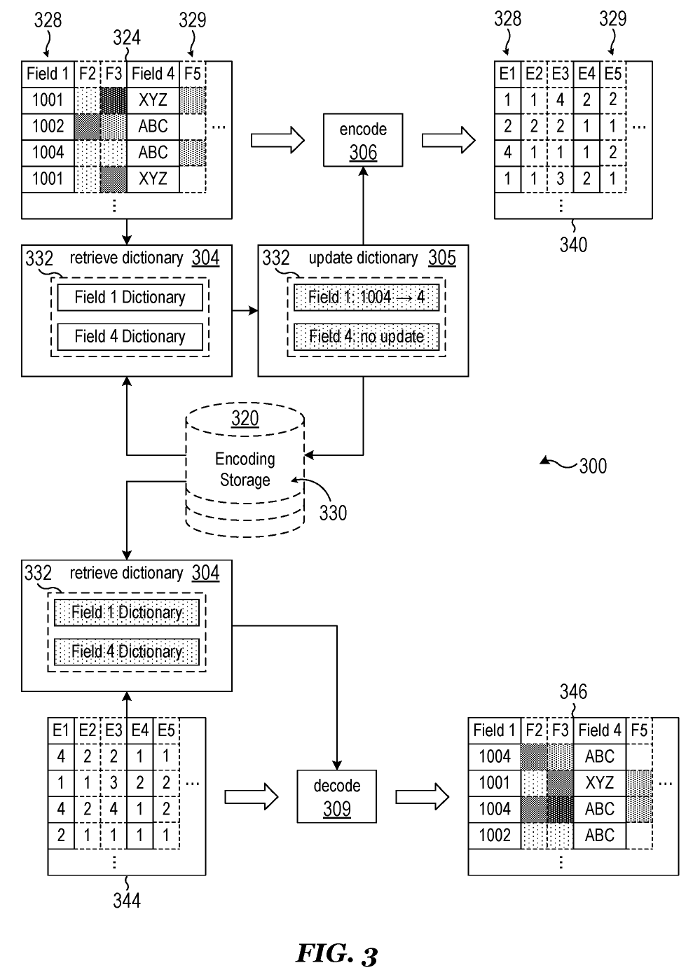

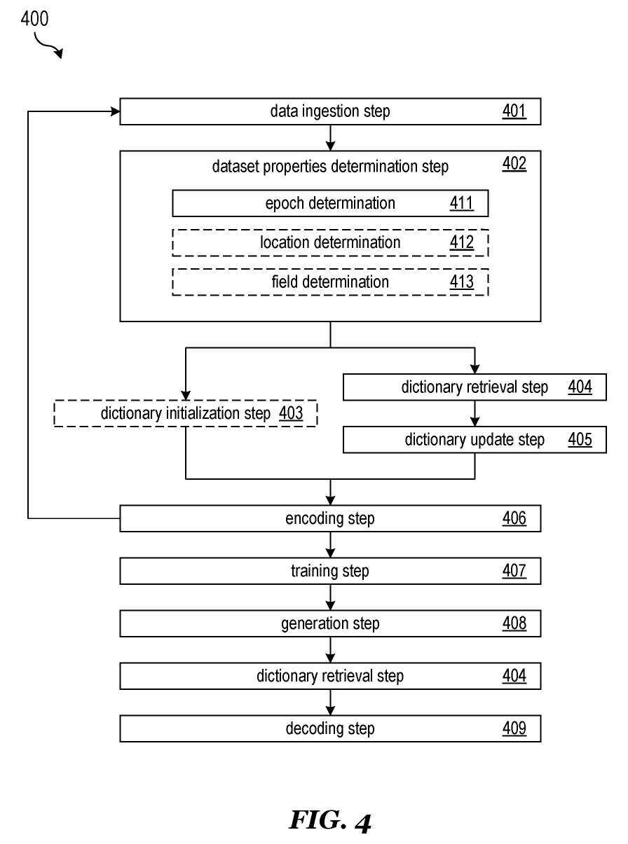

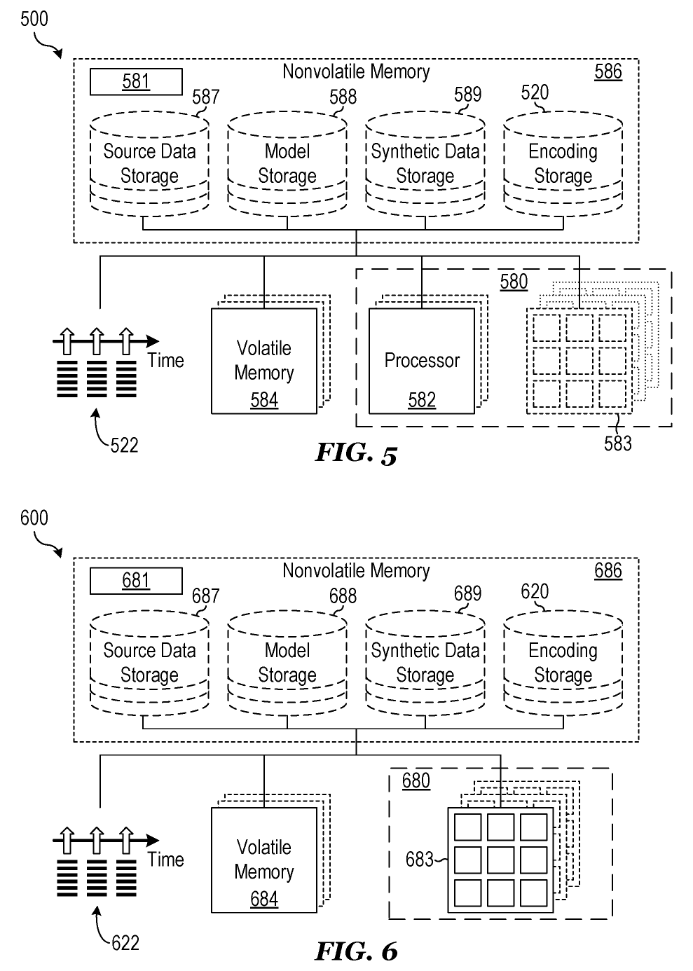

Embodiments provided below describe various methods of encoding source data for training generative models, and in particular embodiments, to methods that use a streamed dictionary that is updated as new data is ingested to generate dictionary snapshots. The following description describes the embodiments. FIG. 1 is used to describe an example encoding process that uses a streamed dictionary to encode streamed data for use in training a model using a neural network. FIG. 2 is used to describe an example synthetic data generation process. An example encoding and decoding process is described using FIG. 3. A method of encoding streamed data is described using FIG. 4. Two example synthetic data generation systems are described using FIGS. 5 and 6.

FIG. 1 illustrates an encoding process 100 for encoding streamed data using a streaming encoding dictionary. During encoding process 100, data (e.g., operational data) arrives continuously over time (shown as time evolution 114, depicted using a black arrow). The time receiving data is divided into a plurality of data epochs 110, each of which represents a discrete time window during which data is collected from one or more data sources. A streamed dataset 124 is gathered during each respective data epoch 110. For example, each streamed dataset 124 may include tabular data comprising multiple fields, where each field contains a set of values observed during the corresponding data epoch 110. Some examples of streamed datasets 124 include network flow records, user transaction logs, application usage traces, and other forms of continuously generated operational telemetry.

For each data epoch 110, a data ingestion step 101 ingests the corresponding streamed dataset 124 into encoding process 100. Upon ingestion, the streamed dataset 124 is used to update the encoding dictionary. A dictionary retrieval step 104 retrieves the latest dictionary snapshot 132 from a streamed dictionary. For the first data epoch, dictionary retrieval step 104 may retrieve an initial or empty dictionary. For each subsequent data epoch, dictionary retrieval step 104 retrieves the dictionary snapshot 132 generated during the immediately preceding data epoch 110 as a baseline (the most recent dictionary snapshot).

A dictionary update step 105 compares the retrieved dictionary snapshot with the relevant fields of the current streamed dataset and updates the streamed dictionary to generate a new dictionary snapshot corresponding to the current data epoch. In this manner, each dictionary snapshot 132 is associated with its respective data epoch 110. An encoding step 106 then encodes the current streamed dataset 124 using the newly generated dictionary snapshot 132 to produce an encoded dataset. The resulting dictionary snapshot 132 is maintained in the streamed dictionary (e.g., stored at least long enough for the next data epoch to use it, or stored in long term storage, such as an encoding storage) so that it can be retrieved during a later data epoch 110 by dictionary retrieval step 104.

As encoding process 100 progresses along time evolution 114, each successive data epoch 110 repeats this sequence of data ingestion step 101, dictionary retrieval step 104, dictionary update step 105, and encoding step 106. For each data epoch 110, the latest dictionary snapshot 132 produced by the preceding data epoch 110 serves as the baseline for dictionary update step 105, which then incorporates any newly observed values from the current streamed dataset 124 to produce an updated dictionary snapshot 132 for the current data epoch. The updated dictionary snapshot 132 is in turn used by encoding step 106 to encode the current streamed dataset 124 and is stored for retrieval during the next data epoch. In this way, the streamed dictionary continuously evolves to maintain coverage of the data domain as it changes over time.

In various embodiments, dictionary snapshots may be associated with other properties in addition to being associated with the current data epoch. For example, dictionary snapshots may include location information indicating a geographic region or logical location at which the corresponding streamed dataset was collected. In another embodiment, dictionary snapshots may include scope information indicating whether the corresponding streamed dataset was collected in a limited or global fashion. In some embodiments, an expanded version of a dictionary snapshot (e.g., a “globalized” version) may be generated by combining dictionary snapshots from multiple locations to produce an expanded scope that reflects the union of values observed across all locations for a given data epoch.

Although shown in FIG. 1 as individual dictionary snapshots, each dictionary snapshot 132 may comprise a combination of individual dictionary mappings, where each dictionary mapping corresponds to a particular field of streamed dataset 124 and maps observed values for that field to encoded representations.

In some embodiments, streamed dataset 124 may include dynamic fields and static fields. Dynamic fields are fields whose domain of values is expected to change over time across successive data epochs 110, such as fields representing websites visited, user identifiers, or device types. Static fields are fields whose domain of values remain unchanged across data epochs 110 (whether they are known to not change or are designated as unchanging due to external domain knowledge). When data ingestion step 101 ingests a streamed dataset 124, the dynamic fields and static fields in streamed dataset 124 may be identified. Dictionary retrieval step 104 may retrieve the latest dictionary snapshots 132 for the dynamic fields from an encoding storage that stores the streamed dictionary.

Dictionary update step 105 may then compare the domain of the dynamic fields in the current streamed dataset 124 with the retrieved dictionary snapshots 132 and update only the dynamic fields of the streamed dictionary to generate dictionary snapshot 132 for the current data epoch. Since the static fields in streamed dataset 124 do not change the scope of their value domain over time, the static fields may not be updated during dictionary update step 105. It should be noted that dictionary mappings for static fields may still be stored along with the dynamic fields, such as in an encoding storage, so that static field dictionaries are also retrieved during dictionary retrieval step 104.

In various embodiments, dictionary update step 105 may perform any number of operations when updating the streamed dictionary. For example, new entries may be added to a dictionary snapshot to account for values in the current streamed dataset that were not present in the previous dictionary snapshot. In some embodiments, existing entries in a dictionary snapshot may be modified, such as when values are reindexed to assign lower-numbered entries to more frequently appearing values. In an embodiment, entries may be removed from a dictionary snapshot, although removal may not be performed in many implementations because the storage overhead associated with retaining expired entries may be negligible relative to the overall system resources. In some embodiments, dictionary update step 105 may evaluate whether individual entries should be updated by applying one or more criteria. For example, for a given field, if a newly observed value does not satisfy a real-world validity criterion, the entry for that value may not be added to dictionary snapshot for that field.

FIG. 2 illustrates a synthetic data generation process 200 for generating synthetic data using a streaming encoding dictionary. Synthetic data generation process 200 extends encoding process 100 described above with respect to FIG. 1 by incorporating the complete end-to-end workflow from data ingestion through training, generation, and decoding of synthetic data.

During synthetic data generation process 200, streamed data 223 is received from a streamed data source 222. Streamed data source 222 may be any source of continuously arriving data, such as network monitoring systems, transaction processing systems, application telemetry collectors, or other data collection infrastructure. Streamed data 223 arrives continuously over time and may be organized into streamed datasets 224, where each streamed dataset 224 corresponds to a particular data epoch representing a discrete time window during which the data was collected.

In various embodiments, streamed datasets 224 may not be obtained directly from streamed data source 222 at the time of collection. In an embodiment, streamed data 223 from streamed data source 222 may be automatically stored in a source data storage 287 as the data arrives. Each streamed dataset 224 stored in source data storage 287 is associated with a specific data epoch. A stored dataset 225 corresponding to an earlier data epoch may be retrieved from source data storage 287 and processed by synthetic data generation process 200 at a later time.

Synthetic data generation process 200 maintains a streamed dictionary 230 in an encoding storage 220. Encoding storage 220 is configured to store streamed dictionary 230 and the dictionary snapshots 232 that compose streamed dictionary 230. Each dictionary snapshot 232 represents the state of the encoding dictionary at a particular point in time and maps observed field values to encoded representations. Streamed dictionary 230 may include multiple dictionary snapshots 232 accumulated over successive data epochs.

For the first streamed dataset processed by synthetic data generation process 200, a dictionary initialization step 203 initializes streamed dictionary 230 in encoding storage 220. Dictionary initialization step 203 creates initial dictionary mappings for the fields present in the first streamed dataset. In various embodiments, dictionary initialization step 203 may also apply to subsequent streamed datasets that contain fields not previously represented in streamed dictionary 230. That is, even if encoding storage 220 already contains dictionary snapshots 232 associated with some or all of the fields in a current streamed dataset 224, if a field in the current streamed dataset 224 is not represented in streamed dictionary 230, dictionary initialization step 203 may initialize a new dictionary mapping for that field within streamed dictionary 230.

For subsequent streamed datasets 224 where all fields have already been initialized in streamed dictionary 230, a dictionary retrieval step 204 retrieves the latest dictionary snapshot 232 from encoding storage 220 providing a baseline against which the current field values can be compared. A dictionary update step 205 compares the retrieved dictionary snapshot with the domain of values present in the fields of the current streamed dataset to determine whether streamed dictionary 230 needs to be updated. If new values are found in the current streamed dataset that are not present in the retrieved dictionary snapshot, dictionary update step 205 updates streamed dictionary 230 and generates a new dictionary snapshot corresponding to the current data epoch. The updated dictionary snapshot is stored in encoding storage 220. In various embodiments, dictionary snapshot 232 may be associated with dataset or dictionary properties, such as a specific data epoch, a geographic or logical location at which the data was collected, a data collection context, or a scope indicator. If the comparison reveals no differences between the retrieved dictionary snapshot and the domain of values in the current streamed dataset, dictionary update step 205 may retain the existing dictionary snapshot without modification.

An encoding step 206 encodes the current streamed dataset using the updated dictionary to produce an encoded dataset 240. Because the dictionary snapshot has been updated to reflect the full domain of values present in the current streamed dataset before encoding step 206 is performed, no values in the current streamed dataset need to be dropped or remapped due to missing dictionary entries. Encoded dataset 240 replaces the original field values in streamed dataset 224 with their corresponding encoded representations as defined by dictionary snapshot 232.

A training step 207 trains a model using encoded dataset 240 to generate a generative model 242. Generative model 242 is a neural network model that has learned the statistical properties and distributions present in encoded dataset 240. Generative model 242 may be associated with metadata that describes properties, workflows, and actions that were used to create generative model 242. In various embodiments, the metadata associated with generative model 242 includes at least an identification of the dictionary snapshot 232 that was used during encoding step 206 to encode the streamed dataset 224 from which generative model 242 was trained. The metadata may also include a configuration workflow that specifies the sequence of preprocessing, encoding, and training operations that produced generative model 242.

A generation step 208 receives generative model 242 and uses generative model 242 to generate an encoded synthetic dataset 244. Because generative model 242 was trained on encoded dataset 240, the generated synthetic dataset contains encoded values that are statistically similar to the encoded values present in encoded dataset 240. Encoded synthetic dataset 244 produces a spread of values in the encoded fields that reflects the statistical distributions learned by generative model 242 from encoded dataset 240.

In order to decode the encoded synthetic dataset 244 into usable synthetic data, the appropriate encoding dictionary is retrieved. Dictionary retrieval step 204 retrieves a dictionary snapshot 232 from encoding storage 220 for use in decoding. The information of which dictionary snapshot 232 was used during encoding step 206 may be obtained during generation step 208 using metadata associated with generative model 242 (e.g., stored along with generative model 242, such as in a model storage). During a decoding step 209, encoded synthetic dataset 244 is decoded using the retrieved dictionary snapshot to generate a synthetic dataset 246, which contains decoded field values that reflect the actual domain of values defined by the dictionary snapshot used during decoding step 209. In some embodiments, decoding step 209 may use the same dictionary snapshot that was used during encoding step 206 for the corresponding streamed dataset. When the same dictionary snapshot is used for both encoding and decoding, synthetic dataset 246 fully reflects the domain of field values that were present in the original streamed dataset from which generative model 242 was trained.

In various embodiments, decoding step 209 may use a different dictionary snapshot than the one used during encoding step 206. The different dictionary snapshot may correspond to a different data epoch, a different location, or a different scope of data collection stored in encoding storage 220. In an embodiment, the different dictionary snapshot may be a dictionary snapshot from a later data epoch that contains additional values not present in the dictionary snapshot used during encoding. This may enable the generation of extrapolated synthetic data that incorporates values that were not present in the original training data. In another embodiment, the different dictionary snapshot may be designated by a user to meet a specific analytical need or scenario modeling objective. When a different dictionary snapshot is used during decoding step 209, the domain of field values in synthetic dataset 246 is dictated by the dictionary snapshot selected for decoding rather than the dictionary snapshot used during encoding.

In some embodiments, decoding step 209 may use a combined dictionary generated by combining multiple dictionary snapshots from encoding storage 220. The multiple dictionary snapshots that are combined may correspond to different data epochs, producing a temporally aggregated dictionary that spans a broader range of observed values. In an embodiment, the multiple dictionary snapshots may correspond to the same data epoch but different locations, producing an expanded dictionary snapshot (e.g., a “globalized” dictionary snapshot) that reflects the union of values observed across all locations for that data epoch. The combined dictionary may then be used by decoding step 209 to decode the encoded synthetic dataset 244. The resulting synthetic dataset 246 reflects the expanded domain of field values defined by the combined dictionary.

In various embodiments, synthetic data generation process 200 may process a stored dataset 225 retrieved from source data storage 287. When processing stored dataset 225 corresponding to an earlier data epoch, dictionary retrieval step 204 retrieves the most recent dictionary snapshot from encoding storage 220 relative to the earlier data epoch, which may be a dictionary snapshot from the earlier data epoch or may be a dictionary snapshot from a data epoch preceding the earlier data epoch. The retrieved dictionary snapshot may be updated to generate a new dictionary snapshot (e.g., if no dictionary snapshot for the earlier data epoch has been created or if other dictionary identifiers such as location or scope do not match the retrieved dictionary snapshot). In other cases, any updates to the dictionary snapshot may be combined into the existing dictionary snapshot (e.g., if the data epoch and other dictionary identifiers match).

FIG. 3 illustrates an encoding and decoding process 300 that focuses on the encoding and decoding operations within synthetic data generation process 200 described above with respect to FIG. 2. Encoding and decoding process 300 includes a schematic representation of datasets before and after encoding and decoding, illustrating how raw field values in a streamed dataset are mapped to compact encoded representations and how encoded synthetic data is decoded back into meaningful field values.

Encoding and decoding process 300 begins with a streamed dataset 324 that contains a plurality of fields. Each field in streamed dataset 324 contains raw data values collected during a particular data epoch. The raw data values may be quite large, particularly for high-cardinality fields such as those representing identifiers, addresses, or other string values. The raw data values may also include substantial duplication across records within streamed dataset 324. These characteristics may present an opportunity for the data values to be encoded into a format that is much smaller than the original representation, reducing the dimensionality of the data prior to generative model training.

In various embodiments, the fields in streamed dataset 324 may include dynamic fields 328 and static fields 329. Dynamic fields 328 are fields whose domain of values is known to or expected to change over time across successive data epochs. As new streamed datasets are ingested during later data epochs, dynamic fields 328 may contain values that were not present in earlier data epochs. Static fields 329 are fields whose domain of values is known to or designated to remain unchanged over time. In the example shown in FIG. 3, Field 1 and Field 4 are dynamic fields 328, while the remaining fields are static fields 329.

A dictionary retrieval step 304 retrieves a dictionary snapshot 332 from a streamed dictionary 330 stored in an encoding storage 320. Dictionary retrieval step 304 retrieves a dictionary snapshot 332 for at least dynamic fields 328 in streamed dataset 324, providing a baseline against which the current values of dynamic fields 328 can be compared. In various embodiments, dictionary retrieval step 304 may also retrieve encoding information for static fields 329 from encoding storage 320 even though static fields 329 do not require a continuously updated streamed dictionary 330. For example, encoding mappings for static fields 329 may still be stored in encoding storage 320.

A dictionary update step 305 compares the retrieved dictionary snapshot with the domain of values present in dynamic fields 328 of the streamed dataset 324 to determine whether streamed dictionary 330 needs to be updated. If streamed dataset 324 contains values in dynamic fields 328 that differ from (e.g., are not present in) the retrieved dictionary snapshot, dictionary update step 305 adds new mappings to dictionary snapshot 332 for those values. In the example shown in FIG. 3, the value 1004 in Field 1 was not previously present in dictionary snapshot 332, and so dictionary update step 305 adds a mapping for the value 1004 to the Field 1 dictionary within dictionary snapshot 332. In the same example, Field 4 does not contain any values that differ from those already represented in dictionary snapshot 332, and so no update is required for Field 4. Because static fields 329 are known to not change the scope of their value domain over time, dictionary update step 305 does not update the dictionary mappings for static fields 329. The updated dictionary snapshot is stored in encoding storage 320 as part of streamed dictionary 330.

An encoding step 306 encodes streamed dataset 324 using the updated dictionary snapshot to generate an encoded dataset 340. Encoded dataset 340 replaces the raw data values in each field of streamed dataset 324 with their corresponding encoded representations as defined by dictionary snapshot 332. The encoded representations in encoded dataset 340 may be compact integer values that are substantially smaller than the original raw data values, reducing the dimensionality of the data for subsequent generative model training. Because dictionary snapshot 332 has been updated by dictionary update step 305 to include mappings for all values present in streamed dataset 324 before encoding step 306 is performed, no values in streamed dataset 324 need to be dropped or randomly remapped during encoding.

During a decoding step 309, an encoded synthetic dataset 344 that was generated using a generative model trained using encoded dataset 340 is decoded using a dictionary snapshot 332 retrieved from encoding storage 320. Decoding step 309 generates a synthetic dataset 346. Specifically, encoded synthetic dataset 344 contains encoded values that are statistically similar to the encoded values in encoded dataset 340. Decoding step 309 reverses the encoding mappings defined by dictionary snapshot 332, replacing each encoded value in encoded synthetic dataset 344 with the corresponding raw data value to produce synthetic dataset 346. The domain of field values in synthetic dataset 346 is determined by the particular dictionary snapshot used during decoding step 309. As described above (such as with respect to FIG. 2), decoding step 309 may use the same dictionary snapshot that was used during encoding step 306, a different dictionary snapshot corresponding to a different data epoch, location, or scope, or a combined dictionary generated by combining multiple dictionary snapshots 332 from encoding storage 320.

FIG. 4 illustrates a method 400 of encoding streamed data for use in training a model using a neural network. Method 400 may include any processes described herein, such as encoding process 100 described with respect to FIG. 1, synthetic data generation process 200 described with respect to FIG. 2, and encoding and decoding process 300 described with respect to FIG. 3. Method 400 may be performed by any of the systems described herein, such as the synthetic data generation systems of FIGS. 5 and 6. Although shown in a logical order, the arrangement and numbering of the steps of FIG. 4 are not intended to be limited. The method steps of FIG. 4 may be performed in any suitable order or concurrently with one another as may be apparent to a person of skill in the art.

Method 400 begins with a data ingestion step 401 that ingests a streamed dataset corresponding to a data epoch. The streamed dataset may be received from a streamed data source that continuously generates data, or the streamed dataset may be a stored dataset retrieved from a source data storage (e.g., previously collected as a data stream and stored), as described above with respect to FIG. 2. The data epoch represents a discrete time window during which the data in the streamed dataset was collected.

Following data ingestion step 401, a dataset properties determination step 402 determines properties of the streamed dataset that are relevant to the encoding process. Dataset properties determination step 402 may include an epoch determination (step 411) that determines the data epoch to which the streamed dataset corresponds. Dataset properties determination step 402 may also include a location determination (step 412) that determines a geographic or logical location at which the streamed dataset was collected. Dataset properties determination step 402 may further include a field determination (step 413) that determines the fields present in the streamed dataset, including which fields are dynamic fields and which fields are static fields. The properties determined during dataset properties determination step 402 may be used in subsequent steps of method 400 to control how the streamed dictionary is retrieved, updated, and associated with the corresponding dictionary snapshot.

In some embodiments, a dictionary initialization step 403 is used to initialize the streamed dictionary for one or more fields of the streamed dataset. Dictionary initialization step 403 may be performed when the streamed dataset is the first dataset processed by method 400 and no prior dictionary exists, or when the streamed dataset contains one or more fields that are not yet represented in the streamed dictionary. In various embodiments, dictionary initialization step 403 may be skipped for fields that already have dictionary mappings in the streamed dictionary.

A dictionary retrieval step 404 retrieves a dictionary snapshot from the streamed dictionary. The dictionary snapshot that is retrieved serves as a baseline against which the field values in the streamed dataset can be compared. In various embodiments, the properties determined during dataset properties determination step 402, such as the data epoch, location, and field information, may be used by dictionary retrieval step 404 to identify and retrieve the appropriate dictionary snapshot from the streamed dictionary. Dictionary retrieval step 404 may retrieve the latest dictionary snapshot available in the streamed dictionary.

In an embodiment when method 400 is used to process a stored dataset corresponding to an earlier data epoch that precedes the most recent data epoch, dictionary retrieval step 404 may retrieve the latest dictionary snapshot that existed before the earlier data epoch from the streamed dictionary. Retrieving the latest dictionary snapshot before the earlier data epoch ensures that the stored dataset is compared against the dictionary state that was current just prior to the time at which the stored data was collected. In this way, updating the streamed dictionary using the stored dataset does not overwrite dictionary snapshots of later data epochs that may have already been generated. However, in some cases an already existing dictionary snapshot corresponding to the earlier data epoch may be combined (e.g., updated, not overwritten) with an updated version of the latest dictionary snapshot, which may result in a dictionary snapshot with expanded domain scope for the earlier data epoch.

A dictionary update step 405 updates the streamed dictionary using the streamed dataset to generate a dictionary snapshot corresponding to the data epoch. Dictionary update step 405 compares the domain of values present in the fields of the streamed dataset with the dictionary snapshot retrieved during dictionary retrieval step 404 and incorporates any changes (e.g., newly observed values) into the streamed dictionary. In various embodiments, dictionary update step 405 may update only the dynamic fields of the streamed dictionary when the streamed dataset includes both dynamic fields and static fields, which may have been determined during dataset properties determination step 402. The dictionary snapshot generated by dictionary update step 405 is associated with the data epoch of the ingested streamed dataset and may also be associated with other properties of the streamed dataset, such as location information or data collection context.

An encoding step 406 is used to encode the streamed dataset using the dictionary snapshot to generate an encoded dataset. Because dictionary update step 405 has already updated the streamed dictionary to reflect the full domain of values present in the streamed dataset before encoding step 406 is performed, the encoded dataset includes encoded representations for all values in the streamed dataset without any values being dropped or randomly remapped.

In various embodiments, method 400 may continuously repeat data ingestion step 401, dataset properties determination step 402, dictionary retrieval step 404, dictionary update step 405, and encoding step 406 for additional datasets corresponding to additional data epochs. Each additional dataset is used to update the streamed dictionary to generate additional dictionary snapshots corresponding to the respective additional data epochs, and each additional dataset is encoded using the respective dictionary snapshot to generate additional encoded datasets. In this manner, the streamed dictionary continuously evolves to maintain coverage of the data domain as it changes over time.

A training step 407 trains a model using the encoded dataset to generate a trained generative model. The trained generative model is a neural network model that has learned the statistical distributions and patterns present in the encoded dataset. In various embodiments, the trained generative model may be associated with metadata that identifies the dictionary snapshot used during encoding step 406.

A generation step 408 generates an encoded synthetic dataset using the trained generative model. The encoded synthetic dataset contains encoded values that are statistically similar to the encoded values in the encoded dataset. Because the trained generative model was trained on encoded data, the synthetic data produced by generation step 408 is also in encoded form.

During a decoding step 409 the streamed dictionary is used to decode the encoded synthetic dataset and generate a decoded synthetic dataset. Decoding step 409 retrieves a dictionary snapshot from the streamed dictionary and uses the retrieved dictionary snapshot to reverse the encoding mappings, replacing each encoded value in the encoded synthetic dataset with the corresponding raw data value.

FIG. 5 illustrates an example synthetic data generation system in accordance with embodiments of the disclosure. The system of FIG. 5 may be used to perform methods and processes described herein, such as the processes of FIGS. 1–3 and the method of FIG. 4, as examples. Similarly labeled elements may be as previously described.

Referring to FIG. 5, a synthetic data generation system 500 includes memory (one or both of volatile memory 584 and nonvolatile memory 586) and one or more processors 580. The memory has at least one non-transitory computer-readable medium storing a program 581 (which here is shown in the nonvolatile memory 586, but may be stored or loaded into the volatile memory 584) including instructions that, when executed by the one or more processors 580, cause the synthetic data generation system 500 to generate synthetic data (e.g., using one or a combination of the methods and processes described herein). The program 581 may include more than one program, some or all of which and may be considered part of a training model or generative model, in some cases.

The implementation details of hardware, software, and geographic locations for the various components of the synthetic data generation system 500 are flexible, and may be determined based on the desired functionality for a given application. For example, the program 581, source dataset(s), streamed dictionary, generative models, and synthetic dataset(s) may all be stored in a single geographic location and/or nonvolatile memory on some embodiments, while in other embodiments, some or all of these structures may be stored in separate locations, whether physically or virtually separated. The nonvolatile memory 586 may include one or more of an encoding storage 520, a source data storage 587, model storage 588, and synthetic data storage 589 as well as one or more streamed data sources 522, each of which may be a separate device and/or in a separate location. For example, source datasets may be stored in database storage (separate or together) and models may be stored in a model bank in some embodiments.

Possible implementations of the nonvolatile memory 586 include all types of readable storage, such as tape-based or disk-based storage, platter drives such as hard drive disk (HDD) storage, solid state drive (SSD) storage, such as flash memory, NVMe SSDs, and others. Similarly, the volatile memory 584 may be implemented in any suitable way, such as various types of random-access memory (RAM), including static RAM (SRAM), dynamic RAM (DRAM), synchronous dynamic RAM (SDRAM), synchronous graphics RAM (SGRAM), high bandwidth memory (HBM), and others. The synthetic data generation system 500 may use hierarchical memory architecture approaches, which different types of memory dedicated to specific machine learning tasks, such as active model training operations, generation operations, and persistent storage of datasets, dictionaries, and/or models.

Similarly, while the one or more processors 580 are configured to execute the program 581, the exact implementation may depend on the specific environment for which the synthetic data generation system 500 is being designed. The one or more processors 580 may include a general purpose processor 582 (or more than one). In some cases, the general purpose processor 582 may be a multicore processor or a distributed processor (including cloud computing implementations). The general purpose processor 582 is a central processing unit (CPU) in one embodiment. In various embodiments, the general purpose processor 582 is a microprocessor, and may take other forms, such as a microcontroller.

The one or more processors 580 may also include a specialized processor 583 (or more than one), such as a processor that is has a structural advantage for efficiently performing machine learning tasks (e.g., parallel processing capability, native matrix operation capability, etc.), such as training or generation tasks. For example, the specialized processor 583 may include a parallel processor, such as a TPU which may be specialized to perform neural network computations, a GPU, and others. In some cases general purpose and specialized processors may be combined, such as in an all-purpose processing unit (APU). In some situations, the specialized processor 583 may be specially designed to perform machine learning tasks or be specially designed to perform methods and processes described herein, such as using one or more ASICs (application-specific integrated circuits), which may be hardwired or programmed, such as using a field-programmable gate array (FPGA).

Of course, any of the above options for the one or more processors 580, the volatile memory 584, and the nonvolatile memory 586 may be combined in any desired combination as may be apparent to those of skill in the art in view of this disclosure. Moreover, while a high-level system overview has been provided for the sake of simplicity, the synthetic data generation system 500 may be implemented as any suitable system, ranging from embedded systems to highly complex systems with multiple compute nodes and parallel data, training, and generation pipelines. The described system components may be implemented individually or in various combinations, with the capability to scale horizontally through the addition of computing nodes or vertically through the enhancement of individual node capabilities.

FIG. 6 illustrates another example synthetic data generation system in accordance with embodiments of the disclosure. The system of FIG. 6 may be used to perform methods and processes described herein, such as the processes of FIGS. 1–3 and the method of FIG. 4, as examples. The synthetic data generation system of FIG. 6 is a specific implementation of the synthetic data generation system of FIG. 5 where the processing capabilities are implemented using specialized processors. Similarly labeled elements may be as previously described.

Referring to FIG. 6, a synthetic data generation system 600 includes a nonvolatile memory 686 storing a program 681 and a volatile memory 684 configured to act as working memory of the synthetic data generation system 600. As before, the nonvolatile memory 686 may be implemented in any suitable way and may include specific virtual or physical storage for datasets and models, such as a one or more of encoding storage 620, source data storage 687, model storage 688, and synthetic data storage 689 as well one or more streamed data sources 622.

In this specific example, the synthetic data generation system 600 includes one or more processors 680 implemented as specialized processor 683. For example, the specialized processor 683 may include TPUs, GPUs, and/or ASICs (whether hardwired or programmable, such as FPGAs) that are specifically configured to perform the synthetic data generation methods and processes described herein. In some embodiments, the synthetic data generation system 600 may be configured to interface with more general purpose system comprising general-purpose processors to facilitate integration of synthetic data generation methods and processes into desired applications.

While the inventive aspects are described primarily in the context of preprocessing and encoding continuously generated data for training deep generative models to produce synthetic data, it should also be appreciated that these inventive aspects may also apply to other data processing and machine learning workflows that rely on encoding dictionaries in streaming or continuously evolving data environments. In particular, aspects of this disclosure may similarly apply to preprocessing pipelines for other forms of machine learning model training beyond generative modeling, such as classification, regression, and clustering models that operate on continuously arriving tabular or structured data; to data compression workflows where encoding dictionaries are used to reduce the size of data for storage or transmission and the data domain evolves over time; to federated learning environments where encoding dictionaries must be maintained and updated across distributed data sources that each contribute new values at different rates; to extract-transform-load pipelines and data warehousing systems that apply encoding transformations to streaming data ingested from multiple heterogeneous sources; and to real-time analytics and stream processing systems that encode high-cardinality fields for efficient aggregation, querying, or indexing as new data continuously arrives.

Example embodiments of the invention are summarized here. Other embodiments can also be understood from the entirety of the specification as well as the claims filed herein.

Example 1. A method of encoding streamed data for use in training a model using a neural network, the method including: ingesting a first streamed dataset corresponding to a first data epoch; updating a streamed dictionary using the first streamed dataset to generate a first dictionary snapshot corresponding to the first data epoch; and encoding the first streamed dataset using the first dictionary snapshot to generate a first encoded dataset.

Example 2. The method of example 1, further including: determining dynamic fields in the first streamed dataset, where remaining fields of the first streamed dataset are static fields, where updating the streamed dictionary includes updating only the dynamic fields of the streamed dictionary to generate the first dictionary snapshot.

Example 3. The method of one of examples 1 and 2, further including continuously: ingesting additional datasets corresponding to additional data epochs; updating the streamed dictionary using the additional datasets to generate additional dictionary snapshots corresponding to the additional data epochs; and encoding the additional datasets using respective snapshots of the additional dictionary snapshots to generate additional encoded datasets.

Example 4. The method of one of examples 1 to 3, further including: ingesting a stored dataset corresponding to an earlier data epoch before the first data epoch; retrieving a latest dictionary snapshot before the earlier data epoch from the streamed dictionary; updating the streamed dictionary using the latest dictionary snapshot and the stored dataset to generate an earlier dictionary snapshot corresponding to the earlier data epoch; and encoding the stored dataset using the earlier dictionary snapshot to generate a second encoded dataset.

Example 5. The method of one of examples 1 to 4, further including: training a model using the first encoded dataset to generate a trained generative model; generating an encoded synthetic dataset using the trained generative model; and decoding the encoded synthetic dataset using the streamed dictionary to generate a decoded synthetic dataset.

Example 6. The method of example 5, where the encoded synthetic dataset is decoded using the first dictionary snapshot, the decoded synthetic dataset corresponding to the first data epoch.

Example 7. The method of example 5, where the encoded synthetic dataset is decoded using a different dictionary snapshot, the decoded synthetic dataset including extrapolated synthetic data corresponding to a different data epoch.

Example 8. The method of one of examples 5 to 7, where the encoded synthetic dataset is decoded using a combined dictionary generated by combining multiple dictionary snapshots of the streamed dictionary.

Example 9. The method of example 8, where the multiple dictionary snapshots correspond to different data epochs.

Example 10. The method of one of examples 8 and 9, where the multiple dictionary snapshots correspond to the same data epoch.

Example 11. A non-transitory computer-readable medium storing a program including instructions that, when executed by one or more processors, encode streamed data for use in training a model using a neural network by: ingesting a first streamed dataset corresponding to a first data epoch; updating a streamed dictionary using the first streamed dataset to generate a first dictionary snapshot corresponding to the first data epoch; and encoding the first streamed dataset using the first dictionary snapshot to generate a first encoded dataset.

Example 12. The non-transitory computer-readable medium of example 11, where the program includes further instructions that, when executed by the one or more processors, encode the streamed data by: determining dynamic fields in the first streamed dataset, where remaining fields of the first streamed dataset are static fields, where updating the streamed dictionary includes updating only the dynamic fields of the streamed dictionary to generate the first dictionary snapshot.

Example 13. The non-transitory computer-readable medium of one of examples 11 and 12, where the program includes further instructions that, when executed by the one or more processors, encode the streamed data by: ingesting a stored dataset corresponding to an earlier data epoch before the first data epoch; retrieving a latest dictionary snapshot before the earlier data epoch from the streamed dictionary; updating the streamed dictionary using the latest dictionary snapshot and the stored dataset to generate an earlier dictionary snapshot corresponding to the earlier data epoch; and encoding the stored dataset using the dictionary snapshot to generate a second encoded dataset.

Example 14. The non-transitory computer-readable medium of one of examples 11 to 13, where the program includes further instructions that, when executed by the one or more processors, encode the streamed data by: training a model using the first encoded dataset to generate a trained generative model; generating an encoded synthetic dataset using the trained generative model; and decoding the encoded synthetic dataset using the streamed dictionary to generate a decoded synthetic dataset.

Example 15. A synthetic data generation system including: one or more processors; a streamed data source; an encoding storage configured to store a streamed dictionary; and at least one non-transitory computer-readable medium storing a program including instructions that, when executed by the one or more processors, cause the synthetic data generation system to generate synthetic data by ingesting a first streamed dataset corresponding to a first data epoch, updating the streamed dictionary using the first streamed dataset to generate a first dictionary snapshot corresponding to the first data epoch, encoding the first streamed dataset using the first dictionary snapshot to generate a first encoded dataset, training a model using the first encoded dataset to generate a trained generative model, generating an encoded synthetic dataset using the trained generative model, and decoding the encoded synthetic dataset using the streamed dictionary to generate a decoded synthetic dataset.

Example 16. The synthetic data generation system of example 15, where the program includes further instructions that, when executed by the one or more processors, encode the streamed data by: ingesting a stored dataset corresponding to an earlier data epoch before the first data epoch; retrieving a latest dictionary snapshot before the earlier data epoch from the streamed dictionary; updating the streamed dictionary using the latest dictionary snapshot and the stored dataset to generate an earlier dictionary snapshot corresponding to the earlier data epoch; and encoding the stored dataset using the dictionary snapshot to generate a second encoded dataset.

Example 17. The synthetic data generation system of one of examples 15 and 16, where the streamed dictionary includes location information of dictionary snapshots in addition to time information.

Example 18. The synthetic data generation system of example 17, where the encoded synthetic dataset is decoded using a combined dictionary generated by combining multiple dictionary snapshots from the encoding storage that correspond to the first data epoch but correspond to different locations to generate a globalized dictionary snapshot corresponding to the first data epoch.

Example 19. The synthetic data generation system of one of examples 15 to 18, where the encoded synthetic dataset is decoded using the first dictionary snapshot, the decoded synthetic dataset corresponding to the first data epoch.

Example 20. The synthetic data generation system of one of examples 15 to 18, where the encoded synthetic dataset is decoded using a different dictionary snapshot, the decoded synthetic dataset including extrapolated synthetic data corresponding to a different data epoch.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method of encoding streamed data for use in training a model using a neural network, the method comprising:
ingesting a first streamed dataset corresponding to a first data epoch;
updating a streamed dictionary using the first streamed dataset to generate a first dictionary snapshot corresponding to the first data epoch; and
encoding the first streamed dataset using the first dictionary snapshot to generate a first encoded dataset.

2. The method of claim 1, further comprising:
determining dynamic fields in the first streamed dataset, wherein remaining fields of the first streamed dataset are static fields,
wherein updating the streamed dictionary comprises updating only the dynamic fields of the streamed dictionary to generate the first dictionary snapshot.

3. The method of claim 1, further comprising continuously:
ingesting additional datasets corresponding to additional data epochs;
updating the streamed dictionary using the additional datasets to generate additional dictionary snapshots corresponding to the additional data epochs; and
encoding the additional datasets using respective snapshots of the additional dictionary snapshots to generate additional encoded datasets.

4. The method of claim 1, further comprising:
ingesting a stored dataset corresponding to an earlier data epoch before the first data epoch;
retrieving a latest dictionary snapshot before the earlier data epoch from the streamed dictionary;
updating the streamed dictionary using the latest dictionary snapshot and the stored dataset to generate an earlier dictionary snapshot corresponding to the earlier data epoch; and
encoding the stored dataset using the earlier dictionary snapshot to generate a second encoded dataset.

5. The method of claim 1, further comprising:
training a model using the first encoded dataset to generate a trained generative model;
generating an encoded synthetic dataset using the trained generative model; and
decoding the encoded synthetic dataset using the streamed dictionary to generate a decoded synthetic dataset.

6. The method of claim 5, wherein the encoded synthetic dataset is decoded using the first dictionary snapshot, the decoded synthetic dataset corresponding to the first data epoch.

7. The method of claim 5, wherein the encoded synthetic dataset is decoded using a different dictionary snapshot, the decoded synthetic dataset comprising extrapolated synthetic data corresponding to a different data epoch.

8. The method of claim 5, wherein the encoded synthetic dataset is decoded using a combined dictionary generated by combining multiple dictionary snapshots of the streamed dictionary.

9. The method of claim 8, wherein the multiple dictionary snapshots correspond to different data epochs.

10. The method of claim 8, wherein the multiple dictionary snapshots correspond to the same data epoch.

11. A non-transitory computer-readable medium storing a program including instructions that, when executed by one or more processors, encode streamed data for use in training a model using a neural network by:
ingesting a first streamed dataset corresponding to a first data epoch;
updating a streamed dictionary using the first streamed dataset to generate a first dictionary snapshot corresponding to the first data epoch; and
encoding the first streamed dataset using the first dictionary snapshot to generate a first encoded dataset.

12. The non-transitory computer-readable medium of claim 11, wherein the program includes further instructions that, when executed by the one or more processors, encode the streamed data by:
determining dynamic fields in the first streamed dataset, wherein remaining fields of the first streamed dataset are static fields,
wherein updating the streamed dictionary comprises updating only the dynamic fields of the streamed dictionary to generate the first dictionary snapshot.

13. The non-transitory computer-readable medium of claim 11, wherein the program includes further instructions that, when executed by the one or more processors, encode the streamed data by:
ingesting a stored dataset corresponding to an earlier data epoch before the first data epoch;
retrieving a latest dictionary snapshot before the earlier data epoch from the streamed dictionary;
updating the streamed dictionary using the latest dictionary snapshot and the stored dataset to generate an earlier dictionary snapshot corresponding to the earlier data epoch; and
encoding the stored dataset using the dictionary snapshot to generate a second encoded dataset.

14. The non-transitory computer-readable medium of claim 11, wherein the program includes further instructions that, when executed by the one or more processors, encode the streamed data by:
training a model using the first encoded dataset to generate a trained generative model;
generating an encoded synthetic dataset using the trained generative model; and
decoding the encoded synthetic dataset using the streamed dictionary to generate a decoded synthetic dataset.

15. A synthetic data generation system comprising:
one or more processors;
a streamed data source;
an encoding storage configured to store a streamed dictionary; and
at least one non-transitory computer-readable medium storing a program including instructions that, when executed by the one or more processors, cause the synthetic data generation system to generate synthetic data by
ingesting a first streamed dataset corresponding to a first data epoch,
updating the streamed dictionary using the first streamed dataset to generate a first dictionary snapshot corresponding to the first data epoch,
encoding the first streamed dataset using the first dictionary snapshot to generate a first encoded dataset,
training a model using the first encoded dataset to generate a trained generative model,
generating an encoded synthetic dataset using the trained generative model, and
decoding the encoded synthetic dataset using the streamed dictionary to generate a decoded synthetic dataset.

16. The synthetic data generation system of claim 15, wherein the program includes further instructions that, when executed by the one or more processors, encode the streamed data by:
ingesting a stored dataset corresponding to an earlier data epoch before the first data epoch;
retrieving a latest dictionary snapshot before the earlier data epoch from the streamed dictionary;
updating the streamed dictionary using the latest dictionary snapshot and the stored dataset to generate an earlier dictionary snapshot corresponding to the earlier data epoch; and
encoding the stored dataset using the dictionary snapshot to generate a second encoded dataset.

17. The synthetic data generation system of claim 15, wherein the streamed dictionary comprises location information of dictionary snapshots in addition to time information.

18. The synthetic data generation system of claim 17, wherein the encoded synthetic dataset is decoded using a combined dictionary generated by combining multiple dictionary snapshots from the encoding storage that correspond to the first data epoch but correspond to different locations to generate a globalized dictionary snapshot corresponding to the first data epoch.

19. The synthetic data generation system of claim 15, wherein the encoded synthetic dataset is decoded using the first dictionary snapshot, the decoded synthetic dataset corresponding to the first data epoch.

20. The synthetic data generation system of claim 15, wherein the encoded synthetic dataset is decoded using a different dictionary snapshot, the decoded synthetic dataset comprising extrapolated synthetic data corresponding to a different data epoch.
